(19) United States
(12) Patent Application Publication
(10) Pub. No.: US 2017/0036721 A1
(43) Pub. Date: Feb. 9, 2017

(54) BICYCLE RACK

(71) Applicant: PEDALSLOT OY, Tampere (FI)

(72) Inventor: Juha RINNE, Tampere (FI)

(73) Assignee: PEDALSLOT OY, Tampere (FI)

(21) Appl. No.: 15/303,948

(22) PCT Filed: Apr. 22, 2015
(86) PCT No.: PCT/FI2015/050280

§ 371 Date: Oct. 13, 2016

(30) Foreign Application Priority Data
Apr. 23, 2014 (FI) 20145375

(51) Int. Cl. B62H 1/08; B62H 3/10

(52) U.S. Cl. CPC B62H 1/08; B62H 3/10

(57) ABSTRACT

A bicycle rack including a first opening which is dimensioned to receive a pedal axle of a bicycle and which first opening is elongated in shape and arranged to be at least substantially on a vertical plane, and a first end of the first opening is arranged to open sideways on the plane and its second end is arranged to open upward of the first end; a mating surface that is arranged at a first distance from the first opening and at least partly at the first opening, the first distance being dimensioned to receive a top part of the pedal crank of the bicycle; a boss space that is arranged below the mating surface to open in the same direction as the first end of the first opening, the boss space being dimensioned to receive a bottom part of the pedal crank.

### BACKGROUND

The invention relates to a bicycle rack.

Many types of racks have been developed for parking bicycles. However, the known racks have problems that relate to the usability of the rack and the support provided by the rack to the bicycle.

### BRIEF DESCRIPTION

The bicycle rack of the invention is characterised by what is disclosed in the characterising part of the independent claim. Other embodiments of the invention are characterised by what is disclosed in the other claims.

Inventive embodiments are also disclosed in the specification and drawings of this application. The inventive contents of the application may also be defined in ways other than those described in the following claims. The inventive contents may also consist of several separate inventions, particularly if the invention is examined in the light of expressed or implicit sub-tasks or in view of obtained benefits or benefit groups. In such a case, some of the definitions contained in the following claims may be unnecessary in view of the separate inventive ideas. Features of the different embodiments of the invention may be applied to other embodiments within the scope of the basic inventive idea.

In the following, features of some embodiments of the invention are listed in a random order:

A first opening, mating surface, boss space and rear surface of the boss space are arranged in a casing structure. An advantage among others is that the pedal crank in its entirety can be positioned inside the rack, whereby detaching a locked bicycle from the rack is extremely difficult.

A first distance is arranged to be adjustable in such a manner that it may increase forced by the pedal crank. An advantage among others is that free play between the rack and bicycle can be reduced.

A first opening is arranged to change its direction between an essentially horizontally arranged first end and an essentially vertically arranged second end. An advantage among others is that it becomes easier to put the pedal crank of the bicycle into the rack.

The second end of the first opening is arranged to be at a 30° to 90° angle, preferably 45° to 80° angle, upward from the horizontal. An advantage among others is that even though it is easy to fasten a bicycle to the rack, it will not detach from the rack by itself.

The rack comprises at least two first openings arranged on top of each other as well as correspondingly arranged mating surfaces. An advantage among others is that bicycles of different sizes can be attached to the rack.

The first opening and mating surface are arranged in relation to each other in such a manner that the first distance is equal in length at both ends of the mating surface. This provides the advantage that the rack is easy to manufacture.

The first opening and mating surface are arranged to converge in such a manner that the first distance is greater close to the first end and smaller close to the second end. An advantage among others is that free play between the rack and bicycle can be reduced.

The first opening and the corresponding mating surface and boss space are arranged to be adjustable in elevation. An advantage among others is that bicycles of different sizes can be attached to the rack.

The first opening, mating surface, and boss space are arranged in relation to each other so as to receive the left pedal axle and pedal crank of the bicycle. An advantage among other things is that the left pedal crank of the bicycle is freely available for fastening.

### BRIEF DESCRIPTION OF THE FIGURES

The invention will be described in greater detail with reference to the attached drawings, in which

FIG. 1 is a schematic representation of a bicycle rack as seen from the left,

FIG. 2 is a schematic representation of the rack according to FIG. 1 as seen from the right,

FIG. 3 is a schematic rear diagonal representation of the rack of FIG. 1 as seen from the left,

FIG. 4 is a schematic front representation of the rack of FIG. 1,

FIG. 5 is a schematic representation of a second rack,

FIG. 6 is a schematic representation of a third rack,

FIGS. 7a to 7c are schematic representations of the use of a rack, and

FIG. 8 is a schematic representation of a fourth rack.

In the figures, the invention is shown simplified for the sake of clarity. In the figures, like reference numerals identify like elements.

### DETAILED DESCRIPTION

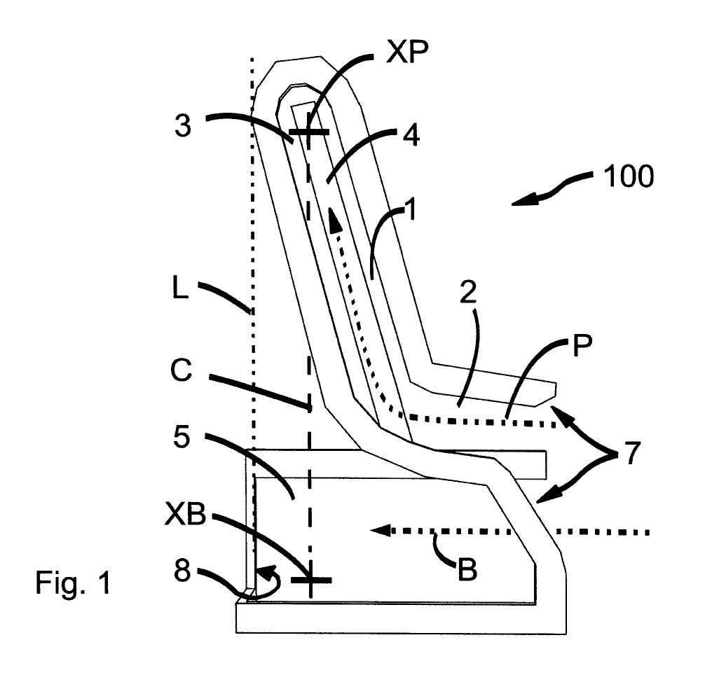

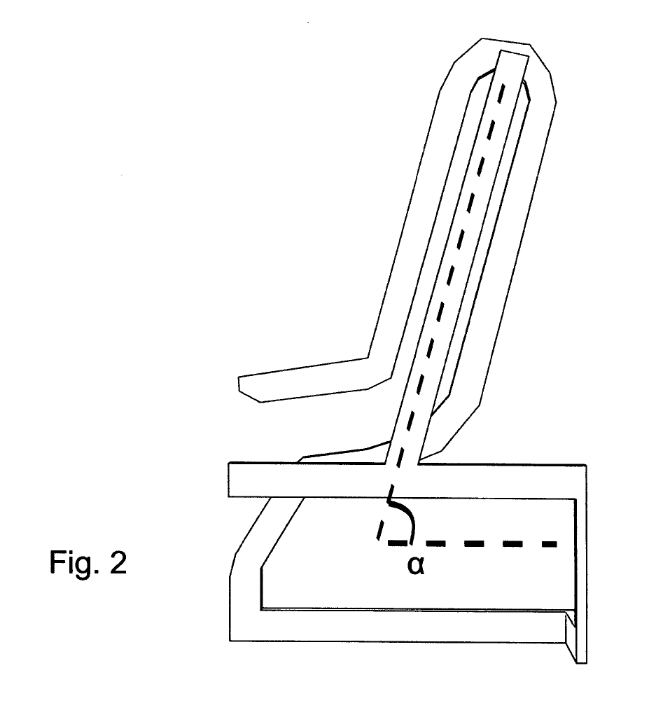

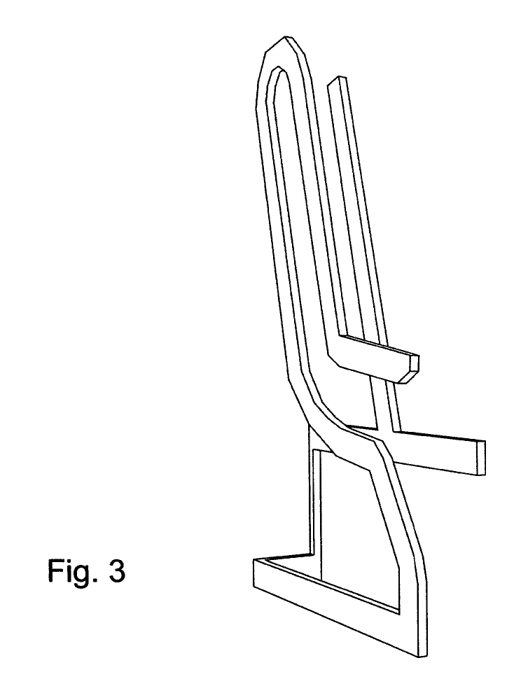

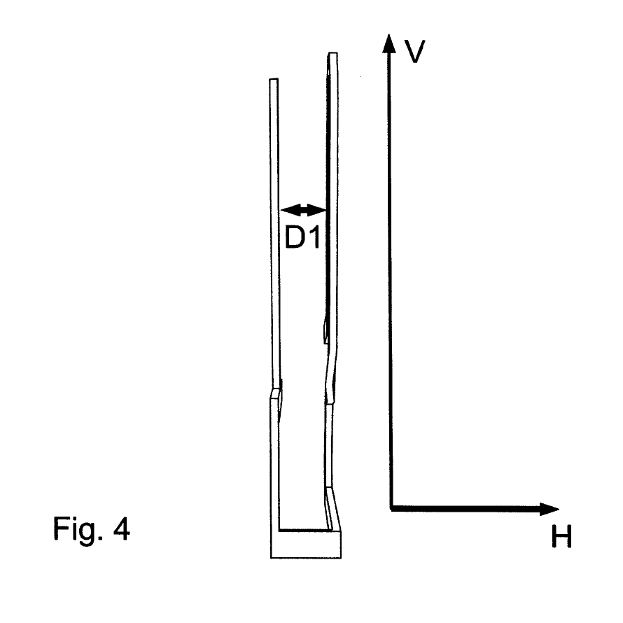

FIG. 1 is a schematic representation of a bicycle rack 100 as seen from the left, FIG. 2 as seen from the right, FIG. 3 as seen diagonally from the rear and left side, and FIG. 4 as seen from the front.

The bicycle rack 100, in the following rack 100, comprises a first opening 1 that is dimensioned to receive the pedal axle of the bicycle. The pedal axle XP of a bicycle is shown in FIG. 1 to be in a location, where it is, when the bicycle is fastened to the rack 100. It should be noted that the location of the pedal axle XP may vary depending on the properties of the bicycle, such as the length of the pedal crank. Arrow P shows the movement of the pedal axle in the first opening 1, when the bicycle is being fastened to the rack 100.

The first opening 1 is elongated in shape and arranged to be at least substantially on a vertical plane—as shown in FIG. 4.

The first opening 1 comprises a first end 2 that is arranged to open to the side, i.e. to the right in FIG. 1, on said vertical plane. In addition, the first opening 1 comprises a second end 3 that is arranged to open upward from the first end 2.

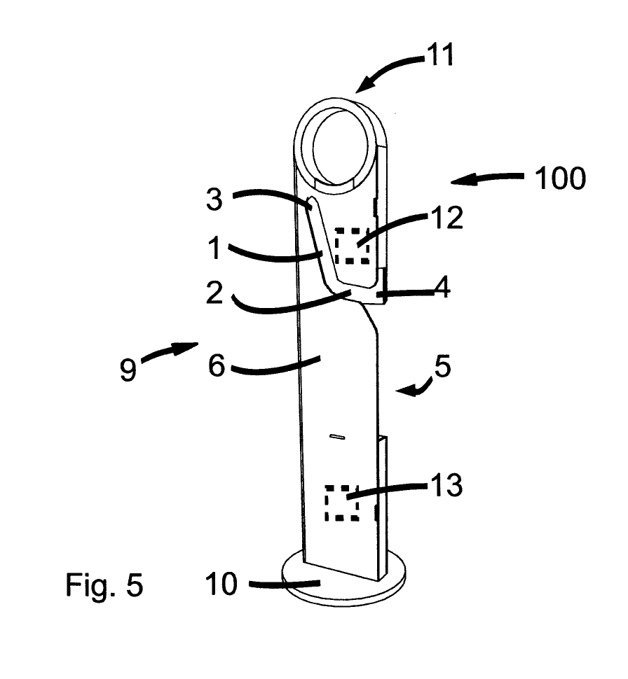

The rack 100 also comprises a mating surface 4 that is arranged at a first distance D1 from said first opening 1, as shown in FIG. 4. The mating surface 4 is arranged to be at least partly at said first opening 1. The mating surface 4 shown herein resembles an upside-down letter T in shape. The mating surface 4 may also be designed in some other manner. An example of this is the plate-like or rectangular mating surface shown in FIG. 5, which is formed by the inner surface of the casing structure.

The first distance D1 is dimensioned in such a manner that the top part of said pedal crank of the bicycle, i.e. the part that comprises the end to which the pedal axle is fastened, fits between the first opening 1 and mating surface 4.

The rack 100 also comprises a boss space 5 that is arranged below the mating surface 4 and dimensioned in such a manner that the bottom part of the pedal crank, i.e. the part that comprises the end to which the crank axle is fastened, fits therein.

The crank axle XB of the bicycle is shown in FIG. 1 to be in a location, where it is when the bicycle is fastened to the rack 100. It should be noted that the location of the crank axle XB may vary depending on the properties of the bicycle, such as the outer diameter of the boss.

Arrow B shows the movement of the crank axle XB into the boss space 5, when the bicycle is being fastened to the rack 100.

The boss space 5 has a rear surface 8 that acts as a surface that stops the movement of the boss or the pedal crank. The rear surface 8 is herein an L-shaped structure, but it is naturally clear that it can also be shaped otherwise. An example of this is the plate-like or rectangular rear surface shown in FIG. 5, which is formed by the inner surface of the casing structure.

The rear surface 8 can be positioned in relation to the extreme end of the second end 3 in such a manner that it is, as seen horizontally, before or after it or on the same level.

In the embodiment shown in FIGS. 1 to 4, the rear surface 8 is in front of the first opening 1, which can be seen from the location of the vertical line L arranged level with the rear surface 8 in relation to the second end 3. The crank axle XB of the bicycle fastened to the rack is then farther on than the pedal axle XP. Naturally, the properties of the bicycle, such as the length of the pedal crank, other dimensions, and the diameter of the boss, also affect the relative location of the crank axle XB and pedal axle XP.

The fact that the pedal crank C is upward of the horizontal and the pedal axle XP is in the first opening 1 such that the wall of the first opening 1 contacts the pedal axle XP, when someone tries to rotate the rear tyre of the bicycle backward, is very significant for the operation of the rack 100.

According to an idea, the rack 100 is dimensioned in such a manner that the angle of the pedal crank is substantially over 90°, for instance 100° to 120°, in a majority of generally used bicycles. The bicycle can then be locked to the rack 100 by preventing the movement of the pedal crank C back to angles of 90° or smaller.

In the first end 2 of the first opening, reception surfaces 7 may be arranged to expand in the opening direction thereof. These facilitate the guidance of the pedal axle into the first opening 1.

The first opening 1 may be straight along its entire length or it may change directions. The first opening 1 shown in FIGS. 1 to 4 comprises a substantially horizontal portion beginning from the first end 2 and a bend or upward turn arranged at a distance from the first end 2, which then continues substantially straight upward. The second end 3 of the embodiment shown in FIGS. 1 to 4 is directed upward at an approximate angle α of 75°. However, it should be noted that the angle may also be of another size. According to an idea, the second end 3 of the first opening is arranged to be at a 30° to 90° angle upward from the horizontal. The bicycle then cannot slip out of the rack 100, but is easy to detach from the rack 100. Even more preferably, the angle is a 45° to 80° angle, which is the optimum range for fastening and detaching a bicycle. Naturally, the angle may also be smaller than 30° or larger than 90°.

The shape and size of the first opening 1 may be varied. In the embodiment shown in FIGS. 1 to 4, the first opening 1 is substantially of a constant width. Instead of such a solution, it is possible to use an opening with a variable width: an evenly converging or evenly expanding or an alternately expanding and converging. The first opening 1 may be both substantially straight and curved in one direction or winding, etc.

The first distance D1 may be of a standard size, in other words, the first opening 1 and mating surface 4 may be arranged parallel to each other. The first distance D1 is then of equal size at both ends of the first opening 1. According to another idea, the first opening 1 and mating surface 4 are arranged to converge in such a manner that the first distance D1 is greater close to the first end 2 and smaller close to the second end 3. In other words, the pedal crank fastened to the pedal axle advancing in the first opening 1 advances into a narrowing gap. The pedal crank C may even wedge into said gap. This way, it is possible to reduce the free play of a bicycle fastened to the rack 100 in relation to the rack 100. According to a third idea, the first distance D1 is adjustable so that it may grow forced by the pedal crank C. This may be implemented, for instance, by arranging on the rack 100 one or more elastic pieces that try to reduce the first distance D1 by acting on either the first opening 1 side surface or the mating surface 4 or both. The elastic element may be a piece or spring made of elastomer, for instance. According to an idea, the piece made of elastomer may be in direct contact with the pedal crank C.

The adjustable distance D1 can also be implemented by forming the first opening 1 and/or mating surface 4 of a suitably flexible metal material.

FIG. 5 is a schematic representation of a second rack. The rack 100 is made into a column 9. The column 9 is formed mainly of a casing structure 6. The first opening 1, mating surface 4, and boss space 5 of the rack are formed into the plate structure forming the surface of the casing structure 6. The plate structure is made of metal, for example.

The column 9 can be fastened in place in an outer or inner space, such as yard area, bicycle parking area or parking garage in manners known per se. The embodiment shown in FIG. 5 comprises a support 10, through which the fastening is done. In an embodiment, there are several columns 9 connected at suitable distances to each other by a frame structure to form a rack group. The rack group can be fastened to a suitable base or fastening location. According to an idea, the column 9 or rack group is not fastened as such, but remains in place by means of a suitably massive support 10 or frame structure.

Functional elements and structures can be arranged to the rack 100. In the embodiment shown in FIG. 5, a ring-shaped fastening means 11 is arranged to the column 9. A bicycle fastened to the rack 100 can be locked to the fastening means 11 with wire, chain or U locks generally used by bicyclists or with any other corresponding separate lock. According to another idea, the fastening means 11 is arranged to the first end 2 or boss space 5 in such a manner that a separate lock can prevent the detaching of the pedal crank C from the rack 100.

According to an idea, the rack 100 comprises an integrated locking means 12, with which the bicycle can be locked to the rack 100. The locking may be based on a latch, for instance, that prevents the detaching of the pedal crank from the rack 100. The latch may also prevent the fastening of the bicycle, whereby unauthorized use of the rack 100 can be prevented. According to an idea, the rack 100 comprises one or more electrically operated components 13. The electrically operated component 13 may receive the electrical energy it uses to operate from outside the rack 100, from an electrical network, or an accumulator or battery arranged to the rack 100, optionally complemented by a solar cell, for example.

The electrically operated component 13 may comprise a light fitting, for instance, that illuminates the rack 100 or its environment.

The electrically operated component 13 may comprise charging means that may be connected to an electrically boosted bicycle, for example, to charge its accumulator.

The electrically operated component 13 may comprise detection means that detect whether a bicycle is fastened to the rack 100 or measure the time that the bicycle has been fastened to the rack 100. The latter embodiment provides the option of implementing paid parking.

The electrically operated component 13 may control the above-mentioned locking means 12. This way, it is possible to implement remote locking of the locking means 12, for example, in other words, the user need not directly operate the locking means 12 to lock the bicycle and release the locking.

The electrically operated component 13 may comprise a display or indicator light that may indicate the time that the bicycle has been fastened to the rack 100 or the charging status of the electrically boosted bicycle being charged in the rack 100, for instance.

According to an idea, means for identifying the bicycle or its user are arranged in the rack 100. The identification can be combined to the locking means 12 in such a manner that the bicycle can either be locked in the rack 100 or detached from the rack 100 on the basis of the identification. The identification may be based on NFC (Near Field Communication) technology, for instance.

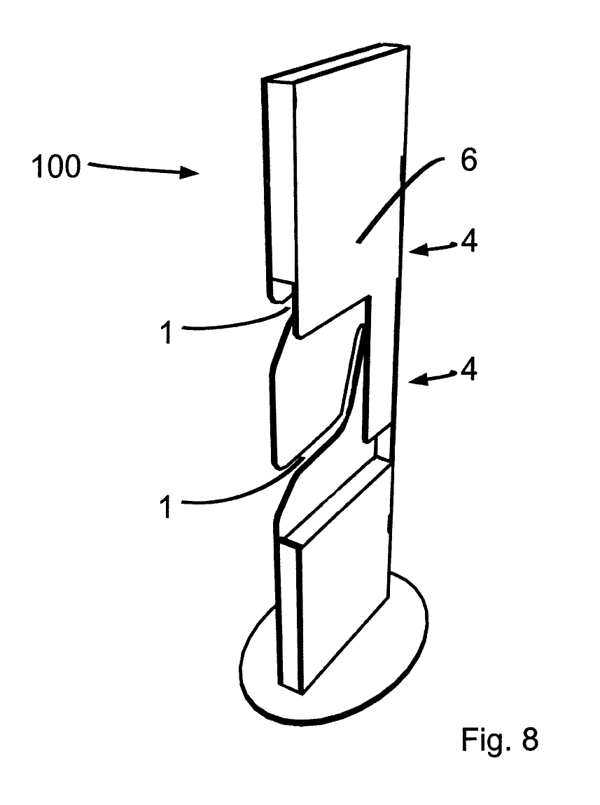

According to an idea, the rack 100 comprises at least two first openings 1 arranged on top of each other and correspondingly arranged mating surfaces 4. This type of embodiment is shown in FIG. 8. According to another idea, the first opening 1 and the corresponding mating surface 4 and boss space 5 are arranged to be adjustable in elevation. The adjustment may be implemented by a telescopic column 9, for instance. Thanks to these solutions, bicycles of different sizes can be attached to the rack 100.

In this context, it should be noted that the column 9 can be shaped in any way as long as it comprises a first opening 1, mating surface 4, boss space 5, and rear surface 8.

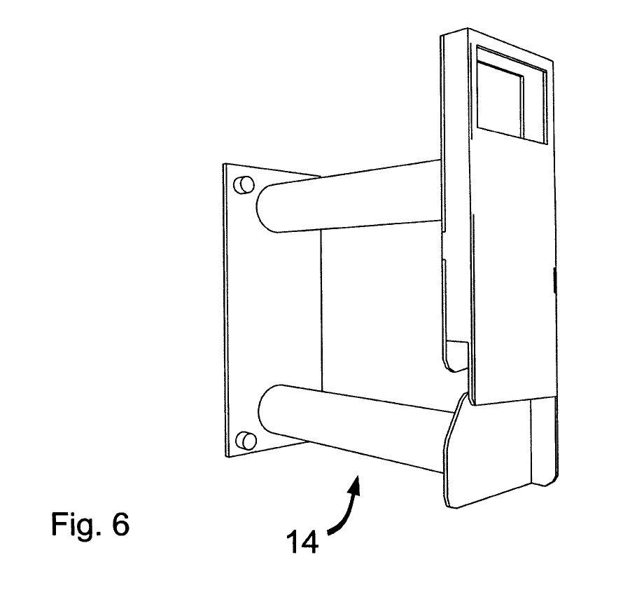

FIG. 6 is a schematic representation of a third rack. The first opening 1, mating surface 4, boss space 5, and rear surface 8 of the rack are formed into the plate structure forming the surface of the casing structure 6. The rack 100 is fastened by means of a support structure 14 to a suitable, substantially vertical surface, such as wall. Otherwise, the rack 100 can be as already described. For instance, the elevation adjustment may be implemented by arranging joints to the support structure 14, on which the first opening 1, mating surface 4, and boss space 5 can be lifted and lowered.

In this context, it should be noted that the rack 100 can be integrated to a park bench, fence, or some other corresponding structure. It is possible to join several racks 100 to each other in various groupings.

The components of the rack 100 can be made of metal, plastic, different composite materials, and other corresponding materials known per se.

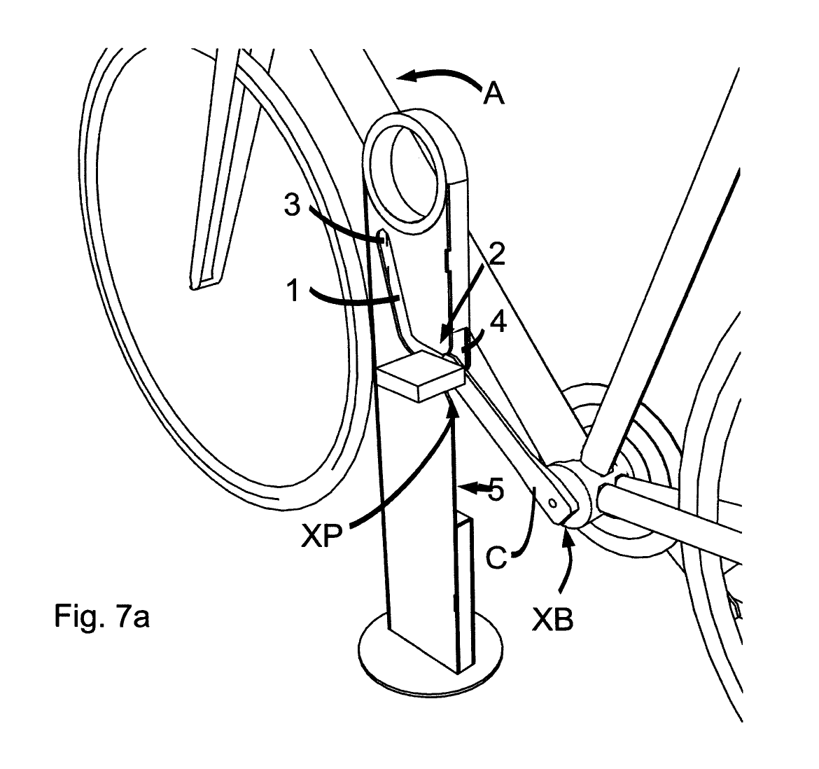

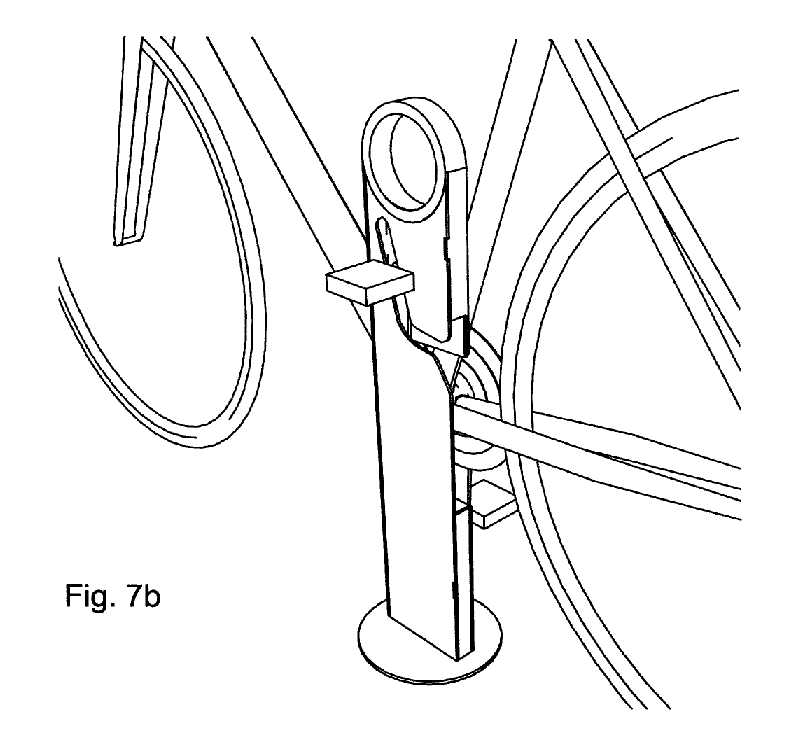

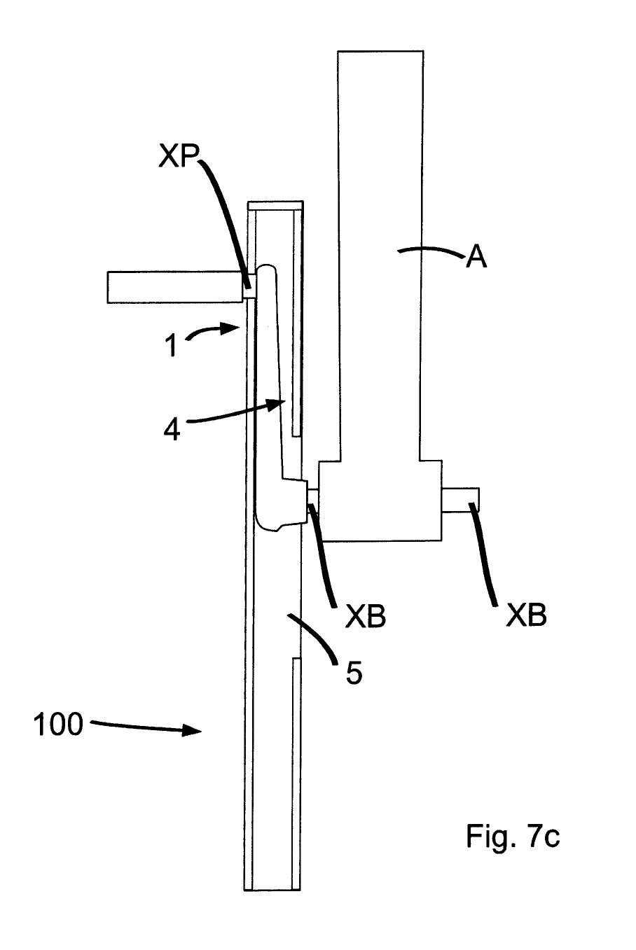

FIGS. 7a to 7c are schematic representations of the use of a rack. The first opening 1, mating surface 4, and boss space 5 are arranged in relation to each other so as to receive the left pedal shaft and pedal crank of the bicycle A.

In FIG. 7a, the bicycle A is being pushed forward on wheels resting on the ground. The part between the pedal and pedal crank C of the pedal axle XP of the left-hand side pedal is at the first end 2 of the first opening 1. When the bicycle A is pushed forward, the pedal axle XP moves forward and/or upward guided by the first opening 1. At the same time, the pedal crank C turns in the opposite direction in relation to the pedalling direction.

In FIG. 7b, the left pedal crank C is in its entirety turned inside the rack 100 so that the bottom part of the pedal crank C is in the boss space 5. In this position, the surfaces of the rack 100 prevent the movement of the pedal crank in the pedalling direction, left, and right. A backward movement of the bicycle is prevented by the rear wheel of the bicycle that is coupled to the pedal axle XP through the power transmission of the bicycle A. A force pushing the bicycle A backward causes a force that tries to turn the pedal crank C as if it were turned against the pedalling direction. However, this movement is prevented, because the pedal axle XP is supported to the first opening 1.

FIG. 7c shows how the pedal crank C rests on the rack 100 in a sideways direction of the bicycle.

To detach the bicycle A from the rack 100, its rear wheel has to be lifted up and the bicycle A pulled simultaneously backward until the pedal crank C is outside the rack 100 in its entirety.

In some cases, features disclosed in this application may be used as such, regardless of other features. On the other hand, when necessary, features disclosed in this application may be combined in order to provide different combinations.

In summary, it can be said that the bicycle rack of the invention is characterised in that it comprises a first opening that is dimensioned to receive a pedal crank of a bicycle, and the first opening is elongated in shape and arranged to be at least substantially on a vertical plane, and a first end of the first opening is arranged to open sideways on said plane and its second end is arranged to open upward of the first end; a mating surface that is arranged at a first distance from said first opening and at least partly at the first opening, the first distance being dimensioned to receive a top part of the pedal crank of the bicycle, in other words, the part that comprises the end of the pedal crank, to which the pedal axle fastens; a boss space that is arranged below said mating surface to open in the same direction as the first end of the first opening, the boss space being dimensioned to receive a bottom part of said pedal crank, in other words, the part that comprises the end of the pedal crank to which the crank axle fastens.

The drawings and the related description are only intended to illustrate the idea of the invention. It is clear to a person skilled in the art that the invention is not restricted to the above embodiments, which disclose the invention by means of a few examples, but that various modifications and different applications of the invention are possible within the inventive idea defined in the accompanying claims.

### REFERENCE MARKINGS

1 first opening
2 first end
3 second end
4 mating surface
5 boss space
6 casing structure
7 receiving surface
8 rear surface of boss space
9 column
10 support
11 fastening means
12 locking means
13 electrically operated component
14 support structure
100 bicycle rack
D1 first distance
A bicycle
B bicycle boss movement
C pedal crank of bicycle
H horizontal plane
L vertical line
P bicycle pedal crank movement
V vertical direction
XB bicycle crank axle
XP bicycle pedal axle
α angle

1-10. (canceled)

11. A bicycle rack comprising
a first opening which is dimensioned to receive a pedal axle of a bi-cycle and which first opening is elongated in shape and arranged to be at least substantially on a vertical plane,
a first end of the first opening being arranged to open sideways on said plane,
a mating surface that is arranged at a first distance from said first opening and at least partly at said first opening, the first distance being dimensioned to receive a top part of the pedal crank of the bicycle, in other words, the part that comprises the end of the pedal crank, to which the pedal axle fastens,
a boss space that is dimensioned to receive a bottom part of said pedal crank, in other words, the part that comprises the end of the pedal crank, to which the crank axle fastens, and to open in the same direction as the first end of the first opening, and
a rear surface of the boss space that is arranged to restrict the boss space at the end opposite to its opening direction,
a second end of the first opening is arranged to open upward from the first end, and
the rack further comprises a boss space which is arranged below said mating surface and which boss space is dimensioned to receive a bottom part of said pedal crank, in other words, the part that comprises the end of the pedal crank, to which the crank axle fastens.

12. A bicycle rack as claimed in claim 11, wherein the first opening, mating surface, boss space and rear surface of the boss space are arranged in a casing structure.

13. A bicycle rack as claimed in claim 11, wherein the first distance is arranged to be adjustable in such a manner that it may increase forced by the pedal crank.

14. A bicycle rack as claimed in claim 11, wherein the first opening is arranged to change its direction between an essentially horizontally arranged first end and an essentially vertically arranged second end.

15. A bicycle rack as claimed in claim 11, wherein the second end of the first opening is arranged to be at a 30° to 90° angle upward from the horizontal.

16. A bicycle rack as claimed in claim 11, comprising at least two first openings arranged on top of each other and correspondingly arranged mating surfaces and boss spaces.

17. A bicycle rack as claimed in claim 11, wherein the first opening and mating surface are arranged in relation to each other in such a manner that the first distance is equal in length at both ends of the mating surface.

18. A bicycle rack as claimed in claim 11, wherein the first opening and mating surface are arranged to converge in such a manner that the first distance is greater close to the first end and smaller close to the second end.

19. A bicycle rack as claimed in claim 11, wherein the first opening and the corresponding mating surface and boss space are arranged to be adjustable in elevation.

20. A bicycle rack as claimed in claim 11, wherein the first opening, mating surface, and boss space are arranged in relation to each other so as to receive the left pedal axle and pedal crank of the bicycle.

21. A bicycle rack as claimed in claim 11, wherein the second end of the first opening is arranged to be at a 45° to 80° angle upward from the horizontal.
